(19) United States
(12) Patent Application Publication
(10) Pub. No.: US 2022/0396723 A1
(43) Pub. Date: Dec. 15, 2022

(54) ABRASIVE MEDIA BLENDS AND RELATED METHODS

(71) Applicant: Sponge-Jet, Inc., Newington, NH (US)

(72) Inventors: Michael T. MERRITT, Newington, NH (US); Edwin D. ZAHARIAS, Newington, NH (US)

(21) Appl. No.: 17/345,524

(22) Filed: Jun. 11, 2021

(51) Int. Cl. C09K 3/14; B24C 11/00

(52) U.S. Cl. CPC C09K 3/1436; B24C 11/00

(57) ABSTRACT

Blends of abrasive media are described that can be propelled via a pressurized air stream into a surface to remove contaminants or other undesired material from the surface. In addition to other advantageous properties, the disclosed abrasive media blends are capable of providing faster abrasion than conventional composite abrasives, but with significantly less dust than raw abrasives generate. The disclosed abrasive media blends include sponge abrasive media formed of a flexible, open-cell polymeric material bonded to one or more abrasive materials.

### FIELD OF THE DISCLOSURE

The present disclosure relates to media for abrasive blasting and related methods of manufacture and use. More particularly, the present disclosure describes blends of abrasive media that can be propelled via a pressurized air stream into a surface to remove contaminants or other undesired material.

### BACKGROUND

Abrasive blasting methods, sometimes referred to as “sandblasting,” “media blasting,” “grit blasting,” or “shot blasting” are techniques in which a stream of abrasive material is forcibly propelled against a surface under high pressure. Abrasive blasting methods can be used for various purposes, such as removing coatings, linings, corrosion, smoothing a rough surface, roughening a smooth surface, shaping a surface, and/or removing surface contaminants. The effects of abrasive blasting are, at least in part, determined by the type of abrasive media used, with highly abrasive media providing more powerful surface abrasion and milder abrasive media providing less surface abrasion. Exemplary types of abrasive media (from most to least abrasive) include silicon carbide, aluminum oxide, metal, garnet, sand, slags, crushed glass, glass beads, plastic media, walnut shells, corncobs, baking soda, and calcium carbonate.

### SUMMARY

Although various abrasives are known and used in the industry, many common raw grit abrasives release large amounts of dust and debris from the surface being treated. The dust and debris generated from the use of conventional raw grit abrasives can present serious health issues for workers and can also further contaminate a work site. Specialized types of abrasive media have been created to address these concerns. For example, some abrasives have been incorporated into pliant media (i.e., sponge-like material) to form composite abrasives. A composite abrasive usually only contains a single type of abrasive material. These known composite abrasives have demonstrated the ability to meaningfully reduce the amount of loose dust generated during abrasive treatments. However, the dust reduction of composite abrasives comes at a cost. Composite abrasives in which abrasive is bound to pliant media can have a much slower abrasion rate than raw grit abrasives. It therefore can take significantly more time to treat a surface with a composite abrasive than a raw grit abrasive.

The disclosed abrasive media blends can include both sponge abrasive media and raw abrasive media. The sponge abrasive media include a flexible, open-cell polymeric material bound or not bound to an abrasive material. In some cases, more than one type of abrasive material can be incorporated into the flexible, open-cell polymeric material. In some such embodiments, the blend may include sponge abrasive media with at least two types of abrasive media integrated therein without any free raw abrasive present. However, in other embodiments raw abrasive media may also be present in the blend along with the sponge abrasive media.

Previously available abrasive materials have required a user to choose whether to select abrasive media that either generates low dust or completes the task in a time-efficient manner. The industry currently lacks abrasive media that can both perform efficiently and minimize dust creation. The presently disclosed abrasive media blends are advantageously able to provide both of these desired features.

Additionally, the disclosed abrasive media blends exhibit synergistic effects as compared its individual components. For example, if a composite abrasive has been shown to abrade at 60% the speed of a raw abrasive, a blend containing both the composite abrasive and raw abrasive would be expected to abrade at 80% the speed of the raw abrasive. However, the presently disclosed blends can, in some embodiments, abrade faster than the raw abrasive itself. In fact, in some cases, the disclosed blends can abrade at twice the speed of the raw abrasive while also producing less dust than the raw abrasive. The increased abrading speeds of the presently disclosed blends are synergistic and wholly unexpected.

It is interesting to note that some of the disclosed raw abrasives and composite abrasives are known and have been used commercially for over thirty years. However, no one has ever attempted to create blends of both raw abrasives and composite abrasives, as described herein, to achieve synergistic effects and superior abrading capabilities. Additionally, no one has ever created composite abrasives containing at least two types of abrasives bound to a single type of flexible, open-cell polymeric material. Even though some of the abrasives used in the presently disclosed blends were previously known, the fact that no one ever attempted to utilize the abrasive blends as described herein in over thirty years is strong evidence that the presently disclosed and claimed subject matter is nonobvious. Additionally, the synergistic effects of the disclosed abrasive media blends also indicate that the subject matter described herein is patentable.

As previously mentioned, some of the presently disclosed abrasive media blends contain no loose (or raw) abrasive and instead are blends in which two or more abrasives are bonded to a single type of polymeric material. These abrasive blends also exhibit unexpected results as compared to previously known abrasives. For example, the disclosed abrasive media blends with at least two types of abrasives bonded to a polymeric material can achieve a deeper profile (i.e., distance from peak to valley in a roughened surface) and/or exhibit significantly faster coating removal speeds than a composite abrasive containing either type of single abrasive bonded to the same polymeric material. For example, while a composite abrasive of 30 mesh aluminum oxide achieves a profile of approximately 125 microns and a composite abrasive of 40 mesh steel grit similarly achieves a profile of approximately 125 microns, when these two abrasives are bonded into a single composite blend, the blend can achieve a profile depth of greater than 200 microns and the coating removal speed is also increased. Particular features of the presently disclosed abrasive media blends are described in additional detail in the following sections.

### BRIEF DESCRIPTION OF THE DRAWINGS

FIGS. 1A-1C illustrate a conventional abrasive blasting method with a raw grit abrasive. In particular, FIG. 1A illustrates the raw grit abrasive being propelled toward a surface, FIG. 1B illustrates the raw grit abrasive making contact with the surface, and FIG. 1C illustrates the dust generated after the raw grit abrasive leaves the surface.

FIGS. 2A-2C illustrate an abrasive blasting method with sponge abrasive media. In particular, FIG. 2A illustrates the sponge abrasive media being propelled toward a surface, FIG. 2B illustrates the sponge abrasive media making contact with the surface, and FIG. 2C illustrates how dust or waste from the surface is captured by the sponge abrasive media.

FIG. 3 shows a chart illustrating the coating removal speeds of a standard abrasive grit, a standard composite abrasive with the same grit in sponge, and two exemplary blends of the same standard abrasive grit with composite media as disclosed herein. Note that the two exemplary blends provide faster production than either of the existing products in standard use and with superior dust control as compared to the raw abrasive.

FIG. 4 shows a chart illustrating production speeds (ft² per minute) in an automated process for railcar lining removal comparing current best practice with composite media compared to the production speed with blended composite media and raw grit.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

Blends of abrasive media are described herein that exhibit unexpected beneficial results as compared to previously known abrasive media. The disclosed blends may include both sponge abrasive media and raw abrasive media as a blend OR two different types of abrasive within the Sponge Abrasive Media. In these and other embodiments, the disclosed blends include sponge abrasive media in which at least two types of abrasive material are integrated into a flexible, open-cell polymeric material OR Sponge Media (with any number of abrasive types bonded in the Sponge or Sponge without abrasive media) blended with one or more non bonded abrasive types which may or may not be the same as the bonded abrasives. Particulars of the disclosed sponge abrasive media and raw abrasive media are described in detail in the following sections. In some embodiments, the blends consist of, consist essentially of, or comprise sponge abrasive media and/or raw abrasive media.

In select embodiments, the blends are formed entirely of sponge abrasive media without any raw abrasive media present. However, in other embodiments, the blends include a ratio of between 95:5 and 5:95 sponge abrasive media to raw abrasive media by volume or by weight. For example, in some embodiments, the blends include between 80:20 and 20:80, 80:20 and 50:50, 70:30 and 50:50, 60:40, and 40:60, 33:67 and 50:50, 30:70 and 50:50, or 25:75 and 45:55 sponge abrasive media to raw abrasive media by volume or by weight. In select embodiments, the blends include more sponge abrasive media than raw abrasive media. In some such embodiments, the blends include between 25:75 and 44:55 sponge abrasive media to raw abrasive media by weight. In select embodiments, the blends contain approximately 33% sponge abrasive media and 67% raw abrasive media by weight. However, numerous variations and other compositions are also possible and contemplated herein.

The raw abrasive media, if present, is a raw grit abrasive material. The raw abrasive media is not a composite; the raw abrasive media is independent from and unbonded to any other components. The raw abrasive media may be any suitable type of abrasive particle(s). For example, in some embodiments, the raw abrasive media may be garnet, steel grit, aluminum oxide, slag, glass, plastics, and/or calcium carbonate or other known abrasives. In some embodiments, a single type of raw grit abrasive is used for the raw abrasive media, whereas in other embodiments the raw abrasive media includes more than one type of raw grit abrasive.

The raw abrasive media within the blend may have a uniform or substantially uniform particle size. In some embodiments, the raw abrasive media has a particle size of between 13.9 microns (500 grit) and 1600 microns (12 grit). In select embodiments, the raw abrasive media has a particle size of between 500 microns (36 grit) and 1,000 microns (20 grit). In particular embodiments, the raw abrasive media has a particle size of approximately 600 microns (30 grit).

The sponge abrasive media present within the blend is a flexible, open-cell polymeric material bonded to an abrasive material. The abrasive material in the sponge abrasive media is bonded to the polymeric material, either by encapsulation, hydrogen bonding, chemical bonding, complex formation, adsorptive, and/or absorptive bonding. The unique structure of abrasive material bound to polymeric material provides the sponge abrasive media with beneficial abrasive properties. For example, the polymeric material can capture dust or other material released from a surface being abraded.

Any type of abrasive material discussed herein relative to the raw abrasive media may be present in the sponge abrasive media. For example, in some embodiments, the sponge abrasive media may be sponge impregnated with one or more of: garnet, steel grit, aluminum oxide, plastics, and calcium carbonate. In particular embodiments, the sponge abrasive media may comprise: sponge impregnated with 30-grit and/or 60-grit garnet; sponge impregnated with G-40 steel grit; sponge impregnated with 16-grit, 30-grit, 60-grit, 80-grit, 120-grit, 220-grit, 320-grit, and/or 500-grit aluminum oxide; sponge impregnated with 30-mesh and/or 40-mesh type 11 plastic urea; and/or sponge impregnated with spherical precipitates of calcium carbonate.

The sponge abrasive media may include between 70%-90% abrasive material by weight, in some embodiments. In particular embodiments, the sponge abrasive media contains approximately 80% abrasive material by weight. The abrasive material may be uniformly dispersed or irregularly dispersed within the polymeric material. The polymeric material of the sponge abrasive media may be any suitable type of polymer, such as urethane, although other examples are possible and contemplated herein.

The sponge abrasive media may include a single type of abrasive material bonded to the polymeric material, whereas in other embodiments, more than one type of abrasive material may be bonded to the polymeric material of the sponge abrasive media. For example, in some embodiments, the sponge abrasive media contains both steel grit and aluminum oxide. Any types of abrasives previously described herein can be incorporated into the disclosed sponge abrasive media that contains at least two integral abrasives. For example, in some embodiments, the disclosed sponge abrasive media may include 45% steel, 45% aluminum oxide, and 10% urethane on a weight basis. In other embodiments, the disclosed sponge abrasive media may include 40% glass, 40% aluminum oxide, and 20% urethane on a weight basis. In alternative embodiments, the disclosed sponge abrasive media may include 80% aluminum oxide and 20% urethane on a weight basis. Numerous variations are also possible and contemplated herein. The sponge abrasive media containing two or more types of abrasives can be produced using any suitable technique. For example, in some embodiments, the two or more types of abrasives may first be combined and then the abrasive blend may be added to the liquid polymer, which ultimately forms the urethane sponge with integral abrasives. As explained below in detail, sponge abrasive media in which two or more types of abrasives are blended into a single flexible, open-cell polymer can provide advantages over other types of previously known abrasives.

Various types of sponge abrasive media are known. For example, U.S. Pat. No. 5,234,470 to Lynn et al., which is incorporated by reference herein, describes examples of sponge abrasive media and methods of manufacture. U.S. Pat. No. 5,146,716 to Lynn, which is also incorporated by reference herein, describes methods of using and recovering sponge abrasive media. Any of the sponge abrasive media described in U.S. Pat. No. 5,234,470 may be used in the disclosed abrasive media blends. Additionally, any uses and recovery techniques described in U.S. Pat. No. 5,146,716 may be used in connection with the disclosed abrasive media blends.

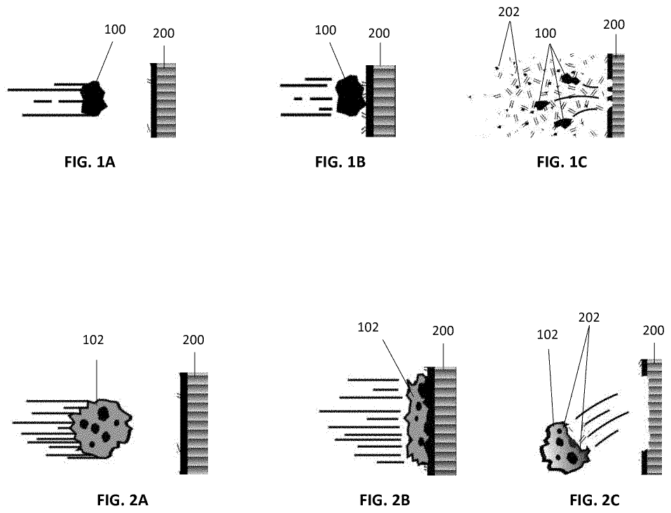

As previously mentioned, the presently disclosed abrasive media blends exhibit superior results when used for abrasive blasting purposes to clean or otherwise treat a surface. FIGS. 1A-1C and 2A-2C are provided herein to illustrate shortcomings of previously known abrasive media to highlight the advantages of the disclosed abrasive media blends. FIGS. 1A-1C illustrate a conventional abrasive blasting process in which a raw grit abrasive 100 is used to treat a surface 200. FIG. 1A illustrates the raw grit abrasive 100 being propelled toward surface 200, FIG. 1B illustrates the raw grit abrasive 100 making contact with surface 200, and FIG. 1C illustrates the dust 202 generated after the raw grit abrasive 100 leaves surface 200. FIGS. 2A-2C illustrate an abrasive blasting process in which a sponge abrasive media 102 is used to treat a surface 200. FIG. 2A illustrates the sponge abrasive media 102 being propelled toward surface 200, FIG. 2B illustrates the sponge abrasive media 102 making contact with surface 200, and FIG. 2C illustrates how dust 202 from surface 200 is captured by the sponge abrasive media 102.

In contrast with previously known abrasives, the presently disclosed abrasive media blends are capable of providing faster and/or deeper abrasion than sponge abrasive media alone, often with significantly less dust than raw grit abrasives generate. For example, in some embodiments, the disclosed abrasive media blends containing both sponge abrasive media and raw abrasive media may abrade a surface at least 50%, 75%, 100%, 200%, 250%, or 300% faster than the sponge abrasive media containing the same abrasive. In these and other embodiments, the disclosed abrasive media blends may generate the same amount of dust or less than the raw abrasive media of the blend generates. For example, in some embodiments, the abrasive media blends may generate 25%, 50%, 75%, or 100% less dust than the amount of dust produced by the raw abrasive media when used in isolation. In some embodiments in which the disclosed abrasive media blends contain two or more types of abrasives bonded to a polymeric material, the blend may achieve a depth profile greater than either abrasive could achieve on its own in combination with the polymeric material. For example, in select embodiments, the abrasive media blend may achieve a depth profile at least 25%, 50%, 75%, or 100% greater than a composite abrasive with only one type of abrasive media bonded to the polymeric material.

The following examples are provided to illustrate particular features of the presently disclosed abrasive media blends.

### Example 1

Exemplary blends according to the present disclosure were created and tested to evaluate abrasive blasting performance as compared to each blend's individual components. The abrasive performance of each blend was tested by removing a coating on a surface to white metal surface cleanliness. Two exemplary blends (Blend A and Blend B) contained the following components and exhibited the following results as compared to each of their individual components. (It should be noted that “Silver 30” is commercial product of composite (or sponge) media which contains 30-36 grit aluminum oxide abrasive bonded into the sponge matrix):

TABLE 1
Blends A and B Compared to Individual Components

| | Abrasion Speed | |
|---|---|---|
| Abrasive Media | (sqft/minute) | Notes |
| Blend A (80% Silver 30¹ by | 4.0 | Similar dust levels |
| volume and 20% Raw Grit | | as Silver 30 |
| Alox 36² by volume) | | |
| Blend B (50% Silver 30 by | 5.0 | Higher dust levels |
| volume and 50% Raw Grit | | than Silver 30 but |
| Alox 36 by volume) | | less dust than Raw |
| | | Grit |
| Silver 30 | 1.5 | Low dust levels |
| Raw Grit Alox 36 | 2.5 | High dust levels |

¹The term “Silver 30” as used herein refers to a sponge abrasive media containing 30 grit aluminum oxide.
²The term “Raw Grit Alox 36” as used herein refers to a raw abrasive media of 36 grit aluminum oxide.

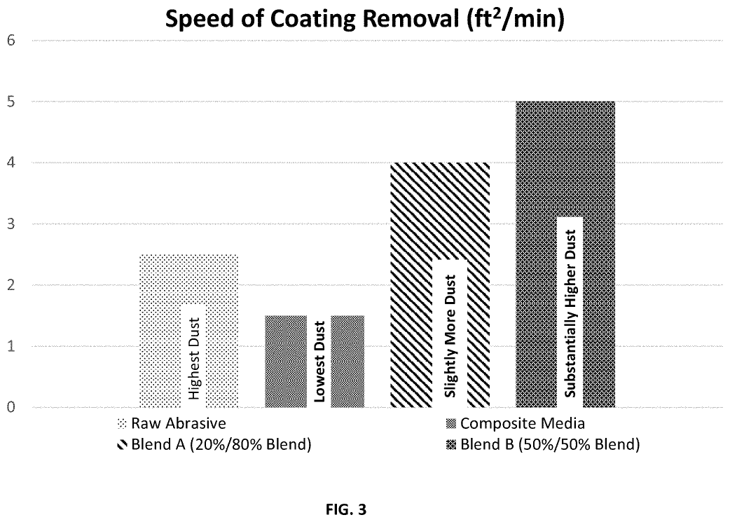

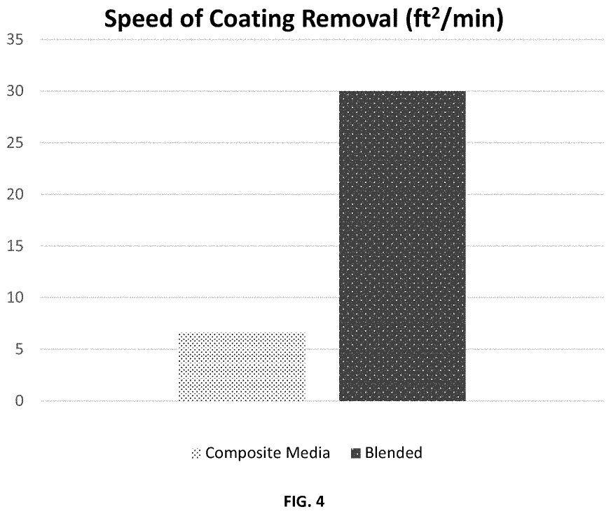

FIG. 3 shows a chart illustrating the coating removal speeds of Blends A and B as compared to the raw abrasive (“Raw Grit Alox 36”) and composite media (“Silver 30”). In this exemplary coating removal test, a food grade coating with single #8 nozzle was used.

### Example 2

An additional exemplary blend (Blend C) was created and tested for abrasive performance by removing a coating to white metal surface cleanliness. Specifically, in this example, a robotic blaster in a rail car was used to remove an 80 mil thick Plasite 4300 coating. Blend C contained the following components and exhibited the following results as compared to its sponge abrasive media:

TABLE 2
Blend C Compared to Sponge Abrasive Media

| | Abrasion Speed |
|---|---|
| Abrasive Media | (sqft/minute) |
| Blend C (approximately 33% Silver 30 by | 30 |
| weight and approximately 67% Raw Grit | |
| Alox 30 by weight) | |
| Silver 30 | 6-7.5 |

These experimental results clearly illustrate that a blend containing both sponge abrasive media and raw abrasive media can be faster at removing coatings than either of the blend's individual components. This result is extremely surprising, especially since the presently disclosed blends can also retain much of the unique characteristics of the sponge abrasive media (e.g., lower dust levels) while also providing increased abrading speeds.

### Example 3

An exemplary blend (Blend D) containing only sponge abrasive media (no raw grit present) was created and tested. Blend D contained 40 mesh steel grit and 30 mesh aluminum oxide particles bound to flexible, open-cell polymeric urethane. Specifically, Blend D contained 40% steel grit, 40% aluminum oxide, and 20% urethane by weight. Table 3 illustrates the profile depth achieved by Blend D as compared to its abrasive components.

TABLE 3
Blend D Compared to Single-Abrasive Sponge Media

| Abrasive Media | Profile Depth (microns) |
|---|---|
| Blend D | >200 |
| Sponge media with 30 mesh aluminum | 125 |
| Sponge media with 40 mesh steel grit | 125 |
| Blend of 50% sponge media with 30 | 125 |
| mesh aluminum and 50% sponge media | |
| with 40 mesh steel grit | |

Blend D exhibited a significantly deeper profile (distance from peak to valley in the surface being abraded) than either of its incorporated abrasives achieved independently in composite (sponge) media. Blend D also had a faster coating removal speed than either of its integral abrasives. In some experiments, Blend D achieved a profile depth of between 8 and 12 mils, which is far greater than currently known types of abrasives. The strong abrasion capabilities of the presently disclosed blends containing at least two types of abrasives bonded to a single type of polymeric material indicates that these blends may be well-suited for removing heavy linings and/or preparing concrete for heaving coatings. Other uses are also possible and contemplated herein.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

1. An abrasive media blend comprising:
a sponge abrasive media, wherein the sponge abrasive media comprises a flexible, open-cell polymeric material by itself or bonded to an abrasive material; and
a raw abrasive media;
wherein the sponge abrasive media and the raw abrasive media are present in a weight ratio of between 95:5 and 5:95 sponge abrasive media to raw abrasive media.

2. The abrasive media blend of claim 1, wherein the sponge abrasive media and the raw abrasive media are present in a weight ratio of between 25:75 and 45:55 sponge abrasive media to raw abrasive media.

3. The abrasive media blend of claim 2, wherein the sponge abrasive media and the raw abrasive media are present in a weight ratio of 33% sponge abrasive media to 67% raw abrasive media.

4. The abrasive media blend of claim 1, wherein the sponge abrasive media contains between 70% and 90% of the abrasive material by weight.

5. The abrasive media blend of claim 4, wherein the sponge abrasive media contains 80% of the abrasive material by weight.

6. The abrasive media blend of claim 1, wherein the flexible, open-cell polymeric material is a urethane.

7. The abrasive media blend of claim 1, wherein the sponge abrasive media contains at least two types of abrasive material bonded to the flexible, open-cell polymeric material.

8. The abrasive media blend of claim 1, wherein the sponge abrasive media contains a single abrasive material bonded to the flexible, open-cell polymeric material.

9. The abrasive media blend of claim 1, wherein the sponge abrasive media is a urethane impregnated with one or more of: garnet, steel grit, aluminum oxide, plastics, and calcium carbonate.

10-13. (canceled)

14. The abrasive media blend of claim 1, wherein a weight percentage of the sponge abrasive media present in the abrasive media blend is greater than a weight percentage of the raw abrasive media present in the abrasive media blend.

15. The abrasive media blend of claim 1, wherein a weight percentage of the raw abrasive media present in the abrasive media blend is greater than a weight percentage of the sponge abrasive media present in the abrasive media blend.

16. The abrasive media blend of claim 1, wherein the raw abrasive media has a particle size between 13.9-1,600 μm.

17. The abrasive media blend of claim 16, wherein the raw abrasive media has a particle size between 500-1,000 μm.

18. The abrasive media blend of claim 17, wherein the raw abrasive media has a particle size of about 600 μm.

19. The abrasive media blend of claim 1, wherein the abrasive material is substantially uniformly integrated into the polymeric material.

20. The abrasive media blend of claim 1, wherein the abrasive material is substantially non-uniformly integrated into the polymeric material.

21. The abrasive media blend of claim 1, wherein the raw abrasive media consists of one or more of: garnet, steel grit, aluminum oxide, slag, glass, plastic, and calcium carbonate.

22. The abrasive media blend of claim 1, wherein the raw abrasive media consists of only a single type of raw grit abrasive.

23. The abrasive media blend of claim 1, wherein the raw abrasive media consists of at least two different types of raw grit abrasive.

24. The abrasive media blend of claim 1, wherein the abrasive material and the raw abrasive media are of the same material composition.
